(19) United States
(12) Patent Application Publication
(10) Pub. No.: US 2023/0400580 A1
(43) Pub. Date: Dec. 14, 2023

(54) METHOD OF PERFORMING DETECTION USING FREQUENCY MODULATED CONTINUOUS WAVE AND LIDAR

(71) Applicant: HESAI TECHNOLOGY CO., LTD., Shanghai (CN)

(72) Inventors: Zhengqing PAN, SHANGHAI (CN); Shaoqing XIANG, SHANGHAI (CN)

(21) Appl. No.: 18/216,438

(22) Filed: Jun. 29, 2023

Related U.S. Application Data
(63) Continuation of application No. PCT/CN2021/104198, filed on Jul. 2, 2021.

(30) Foreign Application Priority Data
Dec. 31, 2020 (CN) 202011623330.8

(51) Int. Cl. G01S 17/58; G01S 7/493

(52) U.S. Cl. CPC G01S 17/58; G01S 7/493

(57) ABSTRACT

A method of performing detection using a frequency modulated continuous wave (FMCW) includes: transmitting a detection wave consistent with a frequency sweep waveform to detect a target object; receiving an echo of the detection wave reflected from the target object; and obtaining a distance to and/or a speed of the target object based on the echo and the detection wave, wherein one cycle of the frequency sweep waveform includes a rising edge, a horizontal region, and a falling edge.

### CROSS-REFERENCE TO RELATED APPLICATIONS

This application is a Continuation Application of International Patent Application No. PCT/CN2021/104198, filed on Jul. 2, 2021, which is based on and claims priority to Chinese Patent Application No. 202011623330.8 filed on Dec. 31, 2020. The entire content of all of the above-referenced applications is incorporated herein by reference.

### TECHNICAL FIELD

The present disclosure relates to the field of photoelectric detection, and in particular, to a method of performing detection using a frequency modulated continuous wave (FMCW) and a lidar.

### BACKGROUND

FIG. 1 shows a structural diagram of a frequency modulated continuous wave (FMCW) radar. A frequency modulated beam (a modulation unit is not shown in the figure) is split into a local oscillator beam and a detection beam through a coupler 1. The detection beam is emitted after passing through a collimating unit, and sweeps a space through a vibrating mirror. A detection beam reflected by a target object (a detection beam echo) is reflected by the vibrating mirror and received by the collimating unit, and re-enters the system to perform coherent beating with the local oscillator beam. Distance and speed information of the target object may be analyzed based on a frequency (always positive) of a beating signal. In FIG. 1, the detection beam echo is received by a detector after passing through a circulator, and then the detection beam echo is mixed with the local oscillator beam in a coupler 2. A processing/processor unit, for example, including a low-pass filtering unit and an A/D sampling unit performs low-pass filtering on the detection beam echo and the local oscillator beam after mixing, to obtain the beating signal, and performs analog-digital conversion and then performs Fast Fourier transform (FFT), to obtain a frequency and its corresponding amplitude of the beating signal between the transmitted signal (the detection beam) and the received signal (the detection beam echo).

Due to a time delay of the echo beam relative to the local oscillator beam, an actual effective beating time period is the difference between a current linear frequency modulation duration and the echo delay time, and the other segments are ineffective beating regions caused by the time delay, as shown in FIG. 2.

In order to obtain the time delay and a Doppler frequency shift of the echo signal at the same time, a combination of linear frequency sweep signals with two slopes may be used. A triangular wave is most frequently used, as shown in FIG. 3A and FIG. 3B. FIG. 3A shows a case without considering the Doppler frequency shift, and FIG. 3B shows a case considering the Doppler frequency shift.

Frequencies f₁ and f₂ of the beating signal at a rising edge and a falling edge of the triangular wave may be expressed as:

f₁=|f_{Z}−fᵥ| (1), and

f₂=|f_{Z}+fᵥ| (2),

where f_{Z} is a frequency shift (i.e., a frequency difference) of the rising edge/falling edge without considering the Doppler frequency shift, as shown in FIG. 3A, and fᵥ is the Doppler frequency shift. According to the above formulas Error! Reference source not found. and Error! Reference source not found., four groups of solutions with respect to f_{Z} and fᵥ may be obtained. Since the distance is always greater than zero: f_{z}>0>0, two sets of solutions may be eliminated. However, as shown in FIG. 4, for a possible signal 1, |fᵥ|>|f_{Z}|, and for a possible signal 2, |fᵥ|<|f_{z}|. Beating results between echo signals and local signals of the two possible signals are the same, and therefore the two possible signals cannot be distinguished from each other. As a result, measurement of high-speed objects in short range cannot be realized by the triangular wave frequency modulation.

Moreover, the FMCW lidar faces the problem of multiple echoes. For example, if the vibrating mirror sweeps excessively fast at an edge of a target object, beating signals in the rising edge and the falling edge will include different measured objects at front and rear. If the vibrating mirror sweeps excessively slow at the edge of the target object, the beating signals in the rising edge and the falling edge will carry reflection information of different objects at front and rear, and therefore it would be difficult to perform correct matching.

The contents of the background are merely technologies known to the inventor, and do not represent prior art.

### SUMMARY

The present disclosure provides a method for detection using a frequency modulated continuous wave (FMCW), including:
transmitting a detection wave consistent with a frequency sweep waveform to detect a target object;
receiving an echo of the detection wave reflected from the target object; and
obtaining at least one of a distance to the target object or a speed of the target object based on the echo and the detection wave, where a cycle of the frequency sweep waveform includes a rising edge, a horizontal region, and a falling edge.

According to an aspect of the present disclosure, the horizontal region is connected to the rising edge and the falling edge during the cycle of the frequency sweep waveform.

According to an aspect of the present disclosure, the horizontal region is separated from the rising edge and the falling edge during the cycle of the frequency sweep waveform.

According to an aspect of the present disclosure, determining the distance frequency shift component f_{z} and the speed frequency shift component fᵥ includes:
determining whether an amplitude corresponding to a frequency f_{d} of a beating signal is greater than or equal to an amplitude threshold, wherein the beating signal is between the detection wave and the echo in the horizontal region;
determining a distance frequency shift component f_{z} and a speed frequency shift component fᵥ depending on whether the amplitude corresponding to the frequency f_{d} of the beating signal is greater than or equal to the amplitude threshold; and
determining at least one of the distance to the target or the speed of the target object based on the distance frequency shift component f_{z} and the speed frequency shift component fᵥ.

According to an aspect of the present disclosure, determining the distance frequency shift component f_{z} and the speed frequency shift component fᵥ includes:
determining which of |f₂+f₁|/2 and |f₂−f₁|/2 is closer to f_{d} when the amplitude corresponding to the frequency f_{d} of the beating signal is greater than or equal to the amplitude threshold, where f₁ is an absolute value of a frequency difference between the detection wave and the echo in the rising edge, and f₂ is an absolute value of a frequency difference between the detection wave and the echo in the falling edge;
in response to determining that |f₂−f₁|/2 is closer than |f₂+f₁|/2 to f_{d}, determining the distance frequency shift component f_{z} and the speed frequency shift component fᵥ according to:

$${f}_{z} = \frac{{f}_{2} + {f}_{1}}{2} , and {f}_{v} = \frac{{f}_{2} - {f}_{1}}{2} ;$$

and
in response to determining that |f₂+f₁|/2 is closer than |f₂−f₁|/2 to f_{d}, determining the distance frequency shift component f_{z} and the speed frequency shift component fᵥ according to: if

$${f}_{1} > {f}_{2} , {f}_{z} = \vert \frac{{f}_{2} - {f}_{1}}{2} \vert ,$$

$$and {f}_{v} = - \frac{{f}_{2} + {f}_{1}}{2} ;$$

$$and if {f}_{1} < {f}_{2} ,$$

$${f}_{z} = \vert \frac{{f}_{2} - {f}_{1}}{2} \vert ,$$

$$and {f}_{v} = \frac{{f}_{2} + {f}_{1}}{2} .$$

According to an aspect of the present disclosure, the method further includes:
determining the presence of multiple echoes based on a determination that at least one of a number of absolute values f₁ of the frequency differences in the rising edge and/or a number of absolute values f₂ of the frequency differences in the falling edge is greater than 1; and
performing echo matching for the multiple echoes, and retaining one of the absolute values f₁ in the rising edge and one of the absolute values f₂ in the falling edge.

According to an aspect of the present disclosure, the echo matching for the multiple echoes comprises: selecting a pair of the absolute values f₁ and f₂ consistent with

$${f}_{d} = \vert \frac{{f}_{2} + {f}_{1}}{2} \vert or {f}_{d} = \vert \frac{{f}_{2} - {f}_{1}}{2} \vert ,$$

and discarding the remaining absolute values f₁ and f₂.

According to an aspect of the present disclosure, determining the distance frequency shift component f_{z} and the speed frequency shift component fᵥ includes: in response to the amplitude corresponding to the frequency f_{d} of the beating signal being less than the amplitude threshold, determining the distance frequency shift component f_{z} and the speed frequency shift component fᵥ according to:

$${f}_{z} = \frac{{f}_{2} + {f}_{1}}{2} , and$$

$${f}_{v} = \frac{{f}_{2} - {f}_{1}}{2} .$$

According to an aspect of the present disclosure, the method further includes:
determining a presence of multiple echoes based on a determination that at least one of a number of absolute values f₁ of the frequency difference in the rising edge and/or a number of absolute values f₂ of the frequency differences in the falling edge is greater than 1; and
performing echo matching for the multiple echoes, and retaining one of the absolute values f₁ in the rising edge and one of the absolute values f₂ in the falling edge.

According to an aspect of the present disclosure, performing echo matching for the multiple echoes comprises:
determining a generated frequency shift F based on a moving speed of a device transmitting the detection wave; and
selecting a pair of the absolute values f₁ and f₂ such that

$$\frac{{f}_{2} - {f}_{1}}{2}$$

is closest to F, and discarding the remaining absolute values f₁ and f₂.

The present disclosure further provides a lidar, including:
a light-emitter, configured to transmit a detection wave consistent with a frequency sweep waveform, wherein a cycle of the frequency sweep waveform includes a rising edge, a horizontal region, and a falling edge;
a mirror unit, configured to receive and reflect and transmit the detection wave to detect a target object;
a sensor unit, where an echo of the detection wave reflected from the target object is reflected by the mirror unit and then incident onto the sensor unit; and
a processor unit, coupled to the light-emitter and the sensor unit and configured to obtain at least one of a distance to the target object or a speed of the target object based on the echo and the detection wave.

According to an aspect of the present disclosure, the horizontal region is connected to the rising edge and the falling edge during the cycle of the frequency sweep waveform.

According to an aspect of the present disclosure, the horizontal region is separated from the rising edge and the falling edge during the cycle of the frequency sweep waveform.

According to an aspect of the present disclosure, the processor unit is configured to:
determine whether an amplitude corresponding to a frequency f_{d} of a beating signal is greater than or equal to an amplitude threshold, wherein the beating signal is between the detection wave and the echo in the horizontal region;
determine a distance frequency shift component f_{z} and a speed frequency shift component fᵥ depending on whether the amplitude corresponding to the frequency f_{d} of the beating signal is greater than or equal to the amplitude threshold; and
determine at least one of the distance to the target object or the speed of the target object based on the distance frequency shift component f_{z} and the speed frequency shift component fᵥ.

According to an aspect of the present disclosure, the processor unit is configured to:
determine which of |f₂+f₁|/2 and |f₂−f₁|/2 is closer to f_{d} when the amplitude corresponding to the frequency f_{d} of the beating signal is greater than or equal to the amplitude threshold, where f₁ is an absolute value of a frequency difference between the detection wave and the echo in the rising edge, and f₂ is an absolute value of a frequency difference between the detection wave and the echo in the falling edge;
in response to determining that |f₂−f₁|/2 is closer than |f₂+f₁|/2 to f_{d}, determine the distance frequency shift component f_{z} and the speed frequency shift component fᵥ according to:

$${f}_{z} = \frac{{f}_{2} + {f}_{1}}{2} , and$$

$${f}_{v} = \frac{{f}_{2} - {f}_{1}}{2} ;$$

and
in response to determining that |f₂+f₁|/2 is closer than |f₂−f₁|/2 to f_{d}, determine the distance frequency shift component f_{z} and the speed frequency shift component fᵥ according to: if

$${f}_{1} > {f}_{z ,} = {f}_{z} \vert \frac{{f}_{2} - {f}_{1}}{2} \vert , and$$

$${f}_{v} = - \frac{{f}_{2} + {f}_{1}}{2} ; and if$$

$${f}_{1} < {f}_{2} , {f}_{z} = \vert \frac{{f}_{2} - {f}_{1}}{2} \vert , and$$

$${f}_{v} = \frac{{f}_{2} + {f}_{1}}{2} .$$

According to an aspect of the present disclosure, the processor unit is configured to:
determine the presence of multiple echoes based on a determination that at least one of a number of absolute values f₁ of the frequency differences in the rising edge or a number of absolute values f₂ of the frequency differences in the falling edge is greater than 1; and
perform echo matching for the multiple echoes, and retain one f₁ in the rising edge and one f₂ in the falling edge.

According to an aspect of the present disclosure, the processor unit configured to perform the echo matching for the multiple echoes is further configured to selecting a pair of the absolute values f₁ and f₂ consistent with

$${f}_{d} = \vert \frac{{f}_{2} + {f}_{1}}{2} \vert or$$

$${f}_{d} = \vert \frac{{f}_{2} - {f}_{1}}{2} \vert ,$$

and discarding the remaining absolute values f₁ and f₂.

According to an aspect of the present disclosure, in response to that the amplitude corresponding to the frequency f_{d} of the beating signal is less than the amplitude threshold, the processor unit is configured to determine the distance frequency shift component f_{z} and the speed frequency shift component fᵥ according to:

$${f}_{z} = \frac{{f}_{2} + {f}_{1}}{2} , and$$

$${f}_{v} = \frac{{f}_{2} - {f}_{1}}{2} .$$

According to an aspect of the present disclosure, the processor unit is configured to:
determine a presence of multiple echoes based on a determination that at least one of a number of absolute values f₁ of the frequency differences in the rising edge or a number of absolute values f₂ of the frequency differences in the falling edge is greater than 1; and
perform echo matching for the multiple echoes, and retain one of the absolute values f₁ in the rising edge and one of the absolute values f₂ in the falling edge.

According to an aspect of the present disclosure, the processor unit configured to perform the echo matching for the multiple echoes is further configured to:
determining a generated frequency shift F based on a moving speed of a device transmitting the detection wave; and
selecting a pair of the absolute values f₁ and f₂ such that

$$\frac{{f}_{2} - {f}_{1}}{2}$$

is closest to F, and discarding the remaining absolute values f₁ and f₂.

The present disclosure is intended to resolve a problem that a current FMCW lidar based on triangular wave frequency sweep has demodulation errors and cannot measure high-speed objects in short range, as well as the multi-echo problem of the FMCW lidar.

### BRIEF DESCRIPTION OF THE DRAWINGS

The drawings forming a part of the present disclosure are used to provide a further understanding of the present disclosure, and the exemplary embodiments and description of the present disclosure are used to explain the present disclosure but do not constitute an improper limitation on the present disclosure. In the drawings:

FIG. 1 is a structural diagram of a frequency modulated continuous wave (FMCW) radar;

FIG. 2 is a schematic diagram showing an effective beating region and an ineffective beating region in the FMCW radar in FIG. 1;

FIG. 3A shows a detection wave and an echo of a triangular wave frequency sweep without considering a Doppler frequency shift;

FIG. 3B shows a detection wave and an echo of a triangular wave frequency sweep considering a Doppler frequency shift;

FIG. 4 shows possible demodulation errors when detecting a high-speed object in short range through a triangular wave frequency sweep;

FIG. 5 shows a method of performing detection using an FMCW consistent with an embodiment of the present disclosure;

FIG. 6A is a schematic diagram of a frequency sweep waveform consistent with an embodiment of the present disclosure;

FIG. 6B is a schematic diagram of a frequency sweep waveform consistent with another embodiment of the present disclosure;

FIG. 6C is a schematic diagram of a frequency sweep waveform consistent with yet another embodiment of the present disclosure;

FIG. 7 is a schematic diagram of a frequency and a corresponding amplitude of a beating signal between a detection wave and an echo in a horizontal region consistent with an embodiment of the present disclosure;

FIG. 8, FIG. 9, and FIG. 10 show detection waves and echoes in three cases respectively, consistent with an embodiment of the present disclosure;

FIG. 11 is a schematic diagram of multi-echo matching consistent with an embodiment of the present disclosure; and

FIG. 12 is a schematic diagram of a lidar consistent with an embodiment of the present disclosure.

### DETAILED DESCRIPTION

Only some exemplary embodiments are briefly described below. As a person skilled in the art can realize, the described embodiments may be modified in various ways without departing from the spirit or the scope of the present disclosure. Therefore, the drawings and the description are to be considered as illustrative in nature but not restrictive.

In the description of the present disclosure, it should be understood that directions or position relationships indicted by terms such as “center”, “longitudinal”, “transverse”, “length”, “width”, “thickness”, “upper”, “lower”, “front”, “rear”, “left”, “right”, “vertical”, “horizontal”, “top”, “bottom”, “interior”, “exterior”, “clockwise”, and “counterclockwise” are based on orientation or position relationships shown in the drawings, are merely used for facilitating the description of the present disclosure and simplify the description, instead of indicating or implying that the indicated apparatus or element needs to have particular orientations or be constructed and operated in particular orientations, and therefore, cannot be construed as a limitation on the present disclosure. Furthermore, the terms “first” and “second” are merely used for descriptive purpose, and should not be interpreted as indicating or implying relative significance or implicitly indicating a quantity of the indicated technical features. Thus, features defined by “first” or “second” may explicitly or implicitly include one or more features. In the description of the present disclosure, unless otherwise explicitly specified, “multiple” means two or more than two.

In the description of the present disclosure, it should be noted that unless otherwise explicitly specified or defined, terms such as “mount”, “couple”, and “connect” should be understood in a broad sense, for example, a fixed connection, a detachable connection; or an integral connection, or a mechanical connection, or an electrical connection or communication with each other; or a direct connection, an indirect connection through an intermediate medium, internal communication between two elements, or an interaction relationship between two elements. A person of ordinary skill in the art may understand the specific meanings of the above terms in the present disclosure consistent with specific situations.

In the present disclosure, unless otherwise explicitly specified and defined, a first feature being “over” or “below” a second feature may mean that the first feature and the second feature are in direct contact, or the first feature and the second feature are not in direct contact but are in contact through another feature therebetween. Moreover, the first feature being “over”, “above”, and “on” the second feature includes that the first feature is directly above or obliquely above the second feature, or merely means that the first feature has a greater horizontal height than the second feature. The first feature being “under”, “below”, and “underneath” the second feature includes that the first feature is directly above or obliquely above the second feature, or merely means that the first feature has a smaller horizontal height than the second feature.

As used herein, unless specifically stated otherwise, the term “or” encompasses all possible combinations, except where infeasible. For example, if it is stated that an object can include A or B, then, unless specifically stated otherwise or infeasible, the object can include A, or B, or A and B. As a second example, if it is stated that an object can include A, B, or C, then, unless specifically stated otherwise or infeasible, the object can include A, or B, or C, or A and B, or A and C, or B and C, or A and B and C. As used herein, unless specifically stated otherwise, the term “and/or” is equivalent to the term “or” as described above.

As used herein, unless specifically stated otherwise, the term “at least one of A or B” encompasses all possible combinations, except where infeasible. For example, if it is stated that an object can include at least one of A or B, then, unless specifically stated otherwise or infeasible, the object can include at least one A, or at least one B, or at least one A and at least one B. As used herein, unless specifically stated otherwise, the term “at least one of A, B or C” encompasses all possible combinations, except where infeasible. For example, if it is stated that an object can include at least one of A, B, or C, then, unless specifically stated otherwise or infeasible, the object can include at least one A, or at least one B, or at least one C, or at least one A and at least one B, or at least one A and at least one C, or at least one B and at least one C, or at least one A and at least one B and at least one C.

The following disclosure provides many different embodiments or examples for achieving different structures of the present disclosure. In order to simplify the disclosure of the present disclosure, components and settings of specific examples are described below. Certainly, they are merely examples, and are not intended to limit the present disclosure. In addition, the present disclosure may repeat reference numerals and/or reference letters in different examples. The repetition is for purpose of simplification and clarity, but does not indicate any relationship between the various implementations and/or settings discussed. Moreover, the present disclosure provides examples of various particular processes and materials, but a person of ordinary skill in the art may realize the application of other processes and/or the use of other materials.

Embodiments of the present disclosure are described below with reference to the drawings. It should be understood that the embodiments described herein are merely used for illustrating and explaining the present disclosure and are not used for limiting the present disclosure.

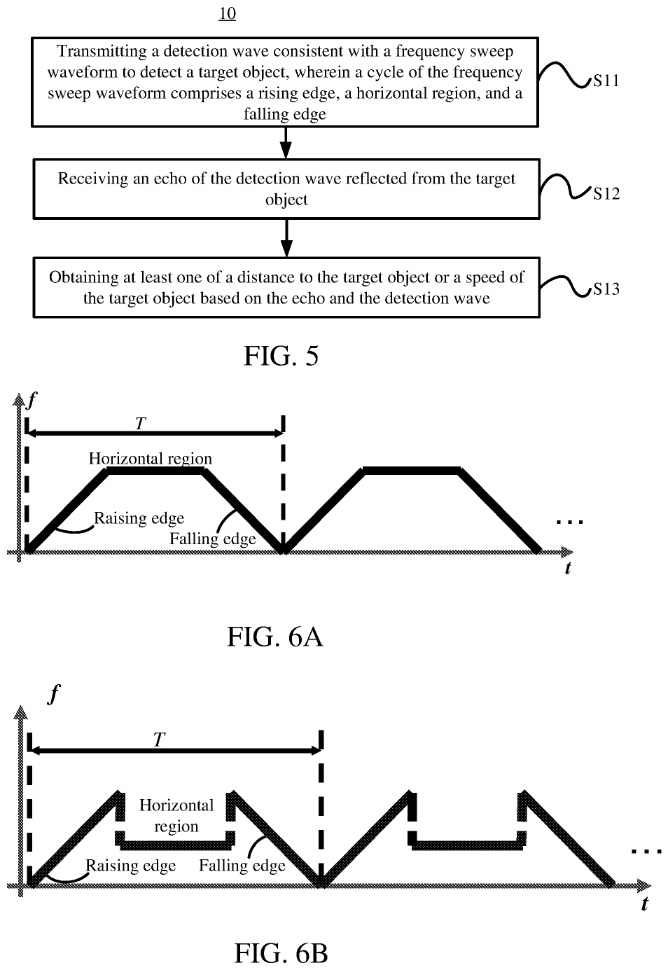

FIG. 5 shows a method 10 for performing detection using a frequency modulated continuous wave (FMCW) consistent with an embodiment of the present disclosure. Detailed description is provided below with reference to the drawings.

Step S11: Transmitting a detection wave consistent with a frequency sweep waveform to detect a target object, wherein the cycle of the frequency sweep waveform includes a rising edge, a horizontal region, and a falling edge. In some embodiments, the frequency sweep waveform may be preset.

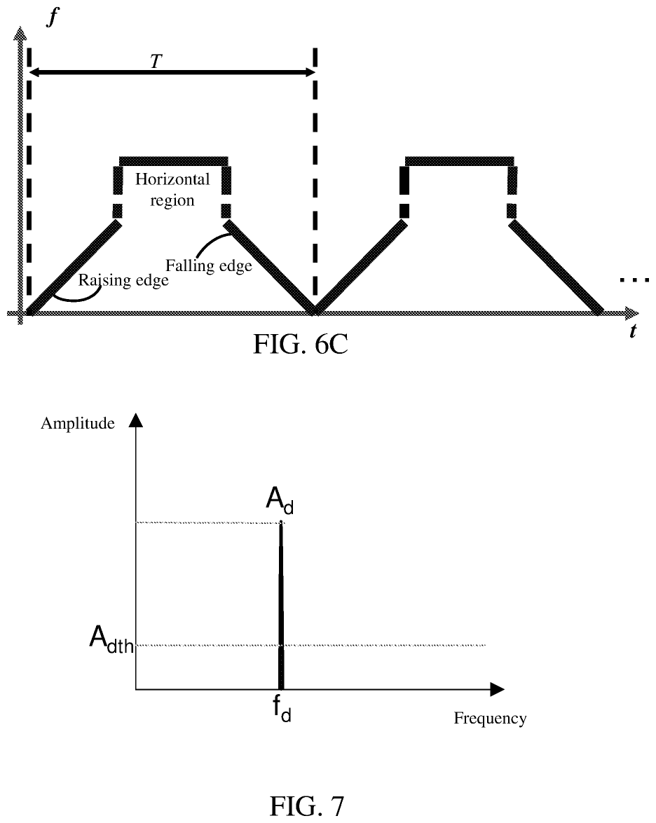

FIG. 6A is a schematic diagram of a frequency sweep waveform consistent with an embodiment of the present disclosure. As shown in FIG. 6A, a cycle T of the frequency sweep waveform includes three stages, namely, a rising edge, a horizontal region, and a falling edge. In the frequency sweep waveform in FIG. 6A, the horizontal region is connected to the rising edge and the falling edge, i.e., the frequency value of the horizontal region is substantially equal to the maximum frequency values of the rising edge and the falling edge. FIG. 6B is a schematic diagram of a frequency sweep waveform consistent with another embodiment of the present disclosure. As shown in FIG. 6B, a horizontal region is separated from a rising edge and a falling edge. In the figure, a frequency value of the horizontal region is different from the maximum frequency values of the rising edge and the falling edge. Moreover, the maximum frequency values of the rising edge and the falling edge may be the same or different. FIG. 6B shows a case in which the maximum frequency values are substantially the same. In some embodiments, the horizontal region may be located above the rising edge and the falling edge, as shown in FIG. 6C. This falls within the scope of the present disclosure.

The present disclosure may adopt the frequency sweep waveforms shown in FIG. 6A, FIG. 6B, and FIG. 6C. Demodulation of the three frequency sweep waveforms are substantially the same. The frequency sweep waveform shown in FIG. 6A is described below as an example.

Step S12: Receiving an echo of the detection wave reflected from the target object. After being transmitted consistent with the frequency sweep waveform, the detection wave is reflected from the target object, and partial echoes return, which are received by a detection device and converted to electrical signals.

Step S13: Obtaining a distance to and/or a speed of the target object based on the echo and the detection wave. That is to say, a frequency and a corresponding amplitude of a beating signal between the echo and the detection wave in each of the sections is obtained through Fast Fourier transform (FFT), and then the distance to and/or the speed of the target object are obtained based on the frequency of the beating signal. In the present disclosure, a three-stage waveform frequency sweep, including the rising edge, the horizontal region, and the falling edge is used, and the three stages form a cycle, to resolve a problem of erroneous determination and/or multi-echo matching caused by a reversal of a frequency of an echo (relative to a detection wave) of a high-speed object in short range. A demodulation process consistent with an embodiment of the present disclosure is described in detail below.

According to an aspect of the present disclosure, step S13 includes:

Step S131: Determining whether an amplitude corresponding to a frequency f_{d} of a beating signal between the detection wave and the echo in the horizontal region is greater than or equal to an amplitude threshold.

A frequency-time waveform of the echo is usually the same as or close to a frequency-time waveform of the detection wave. In the present disclosure, since the frequency sweep waveform of the detection wave includes the rising edge, the horizontal region, and the falling edge, a frequency waveform of the echo includes a rising edge, a horizontal region, and a falling edge. FIG. 7 shows the frequency sweep waveform of the detection wave and the frequency waveform of the echo. After the echo is received, beating is performed on the echo and the detection wave, to obtain frequencies and corresponding amplitudes of the beating signal between the echo and the detection wave at the rising edge, the horizontal region, and the falling edge through transformation, and then the frequency f_{d} of the beating signal in the horizontal region and a corresponding amplitude are read. The frequency f_{d} of the beating signal in the horizontal region is an absolute value of a frequency difference between the detection wave and the echo in the horizontal region. It is then determined whether the amplitude corresponding to the frequency f_{d} of the beating signal in the horizontal region is greater than or equal to the amplitude threshold.

In the present disclosure, the frequency f_{d} of the beating signal between the detection wave and the echo in the horizontal region is closely related to a speed frequency shift component fᵥ having the same absolute value. However, f_{d} is always positive, and fᵥ may be positive or negative depending on its direction. Step S132: Determining a distance frequency shift component f_{z} and a speed frequency shift component fᵥ depending on whether the amplitude corresponding to the frequency f_{d} of the beating signal between the detection wave and the echo in the horizontal region is greater than or equal to the amplitude threshold. A calculation manner consistent with an embodiment of the present disclosure is described below.

FIG. 7 is a schematic diagram of a frequency and a corresponding amplitude of a beating signal between a detection wave and an echo in a horizontal region. In the figure, a corresponding amplitude of the frequency f_{d} of the beating signal between the detection wave and the echo in the horizontal region is A_{d}, and an amplitude threshold is A_{dth}. In the figure, A_{d} is greater than A_{dth}. The amplitude threshold is determined based on a noise amplitude when no echo exists. For example, A_{dth} is 6 times the noise amplitude when no echo exists, or A_{dth} may be set according to an actual situation.

It is determined which of |f₂+f₁|/2 and |f₂−f₁|/2 is closer to f_{d} when the amplitude corresponding to the frequency f_{d} of the beating signal between the detection wave and the echo in the horizontal region is greater than or equal to the amplitude threshold. f₁ is an absolute value of a frequency difference between the detection wave and the echo in the rising edge, and f₂ is an absolute value of a frequency difference between the detection wave and the echo in the falling edge.

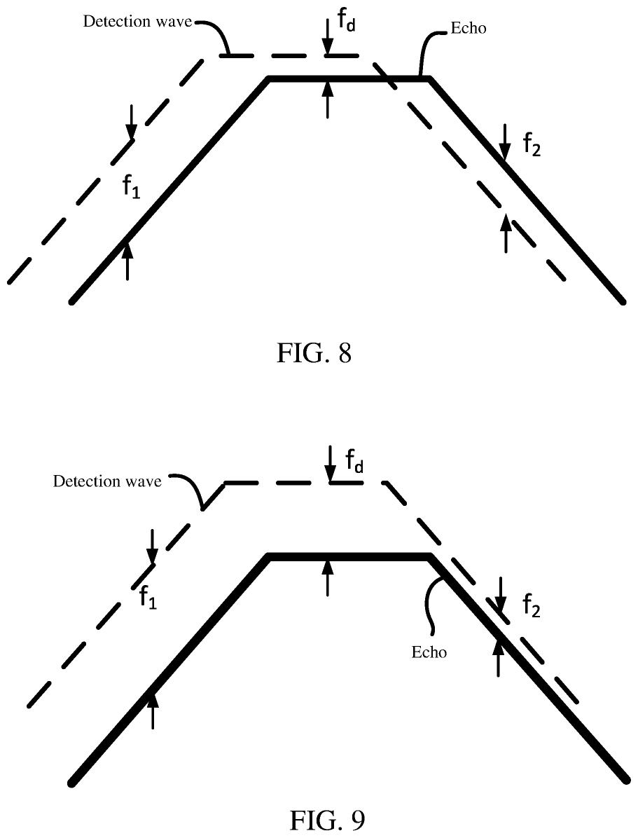

When |f₂−f₁|/2 is closer to f_{d}, for example, when |f₂−f₁|/2≈f_{d}, it indicates that |f_{Z}|>|fᵥ|, which represents that at this time no change in frequency sign occurs at the rising edge and the falling edge (i.e., at the rising edge, the echo is located below the detection wave; and at the falling edge, the echo is located above the detection wave), and a Doppler frequency shift (a speed frequency shift component) exists, but the speed frequency shift component fᵥ is smaller than the distance frequency shift component f_{z}. Frequencies of the detection wave and the echo are shown in FIG. 8. Therefore, the distance frequency shift component f_{z} and the speed frequency shift component fᵥ are determined in the following manner:

$${f}_{z} = \frac{{f}_{2} + {f}_{1}}{2} , and$$

$${f}_{v} = \frac{{f}_{2} - {f}_{1}}{2} .$$

When |f₂+f₁|/2 is closer to f_{d}, for example, when |f₂+f₁|/2≈f_{d}, it indicates that |f_{Z}|<|fᵥ|, and the distance frequency shift component f_{z} and the speed frequency shift component fᵥ are determined in the following manner: If f₁>f₂, a Doppler frequency shift exists, but the speed frequency shift component fᵥ is greater than the distance frequency shift component f_{z}, and the speed frequency shift component fᵥ is negative. Frequencies of the detection wave and the echo are shown in FIG. 9 (at the rising edge, the echo is located below the detection wave; and at the falling edge, the echo is located below the detection wave, a reversal occurs at the falling edge). In this case,

$${f}_{z} = \vert \frac{{f}_{2} - {f}_{1}}{2} \vert , and$$

$${f}_{v} = - \frac{{f}_{2} + {f}_{1}}{2} .$$

If f₁<f₂, a Doppler frequency shift exists, but the speed frequency shift component fᵥ is greater than the distance frequency shift component f_{z}, and the speed frequency shift component fᵥ is positive. Frequencies of the detection wave and the echo are shown in FIG. 10 (at the rising edge, the echo is located above the detection wave, a reversal occurs at the rising edge; and at the falling edge, the echo is located above the detection wave). In this case,

$${f}_{z} = \vert \frac{{f}_{2} - {f}_{1}}{2} \vert , and$$

$${f}_{v} = \frac{{f}_{2} + {f}_{1}}{2} .$$

According to an aspect of the present disclosure, step S132 includes: When the amplitude corresponding to the frequency f_{d} of the beating signal between the detection wave and the echo in the horizontal region is less than the amplitude threshold, that is, A_{d} is less than A_{dh}, it may be considered that no f_{d} exists. Such situation is usually caused by a long distance, a small echo signal, or a small moving speed. In this case, the distance frequency shift component f_{z} and the speed frequency shift component fᵥ may be determined in the following manner:

$${f}_{z} = \frac{{f}_{2} + {f}_{1}}{2} , and$$

$${f}_{v} = \frac{{f}_{2} - {f}_{1}}{2} .$$

Step S133: Determining the distance to and the speed of the target object based on the distance frequency shift component f_{z} and the speed frequency shift component fᵥ. After the distance frequency shift component f_{z} and the speed frequency shift component fᵥ are obtained, the distance to and the speed of the target object may be respectively determined. In a lidar system, a distance coefficient factor_z and a speed coefficient factor_v are initial calibration values. The distance frequency shift component f_{z} and the speed frequency shift component fᵥ may be respectively multiplied by the distance coefficient factor_z and the speed coefficient factor_v to determine the distance to and the speed of the target object.

FIG. 8, FIG. 9, and FIG. 10 show a frequency waveform of one echo. During lidar detection, if a vibrating mirror sweeps excessively fast at an edge of an object, frequency waveforms of multiple echoes appear, and the beating signals in the rising edge and the falling edge include different measured objects at front and rear. If the vibrating mirror sweeps excessively slow at the edge of the target object, the beating signals in the rising edge and the falling edge may carry reflection information of various objects at front and rear, and therefore correct matching is required.

According to an embodiment of the present disclosure, it may be determined whether multiple echoes exist, and matching is performed when the multiple echoes exist, i.e., a pair of f1 and f2 in the rising edge and the falling edge matching each other is retained. For example, when the amplitude corresponding to the frequency f_{d} of the beating signal between the detection wave and the echo in the horizontal region is greater than or equal to the amplitude threshold, if a number of absolute values f₁ of the frequency differences in the rising edge or a number of absolute values f₂ of the frequency differences in the falling edge is greater than 1, it is considered that multiple echoes exist (for example, as shown in FIG. 4), and matching is required. At this time, a pair of f₁ and f₂ satisfying

$${f}_{d} = \vert \frac{{f}_{2} + {f}_{1}}{2} \vert or$$

$${f}_{d} = \vert \frac{{f}_{2} - {f}_{1}}{2} \vert$$

is sought

$$\frac{\vert f 2 + f \vert}{2} = fd . \frac{\vert f 2 - f 1 \vert}{2} = fd$$

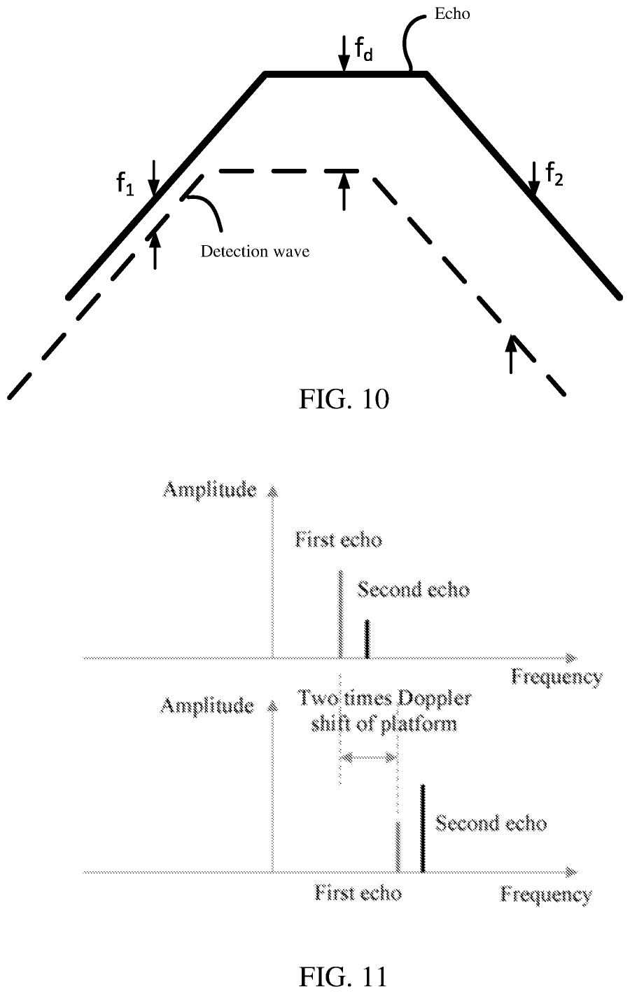

It is considered that f₁ and f₂ are a matching pair. f₁ and f₂ satisfying the above condition are retained, and the remaining absolute values f₁ and f₂ are discarded. FIG. 11 is a schematic diagram of multi-echo matching. An upper part shows a beating spectrum at the rising edge, and a lower part shows a beating spectrum at the falling edge. As shown in FIG. 11, two f₁ are generated at the rising edge and two f₂ are generated at the falling edge. Through the above matching, a first echo at the rising edge and a first echo at the falling edge satisfy the above matching relationship and are retained. Other echoes are discarded and used in subsequent data processing.

When the amplitude corresponding to the frequency f_{d} of the beating signal between the detection wave and the echo in the horizontal region is smaller than the amplitude threshold, and the number of the absolute values f₁ of the frequency differences in the rising edge and/or the number of the absolute values f₂ of the frequency differences in the falling edge is greater than 1, a generated frequency shift F may be determined based on a moving speed of a device transmitting the detection wave, and then a pair of f₁ and f₂ with

$$\frac{{f}_{2} - {f}_{1}}{2}$$

closest to F is selected, and the remaining absolute values f₁ and f₂ are discarded. In this case, if a frequency shift generated by a relative speed of a surrounding object due to advancement of a vehicle is F, F may be obtained through a speed sensor of the vehicle or through real-time analysis of the speed of the surrounding object. Based on a multi-echo matching of the speed, an echo signal from a stationary object is preferentially selected in the multiple echoes.

Therefore, when multiple echoes exist, a matching may be performed in the above manner, to retain a pair of f₁ and f₂, and then the distance frequency shift component f_{z} and the speed frequency shift component fᵥ are determined in the following manner:

$${f}_{z} = \frac{{f}_{2} + {f}_{1}}{2} , and$$

$${f}_{v} = \frac{{f}_{2} - {f}_{1}}{2} .$$

In the above-described embodiment of the present disclosure, three-stage periodic waveform frequency sweep is performed, which can resolve the existing problem of erroneous modulation in measurement of high-speed objects in short range and the problem of a failure of matching the multiple echoes caused by triangular wave frequency sweep.

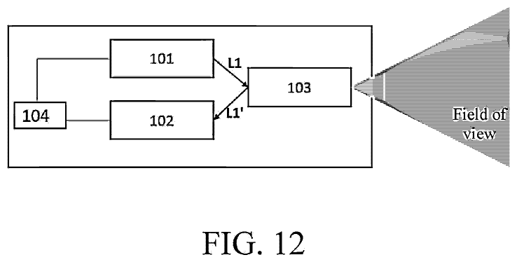

FIG. 12 shows a lidar 100 consistent with an embodiment of the present disclosure. The lidar is applicable to the above-mentioned method 10. Detailed description is provided below with reference to the drawings.

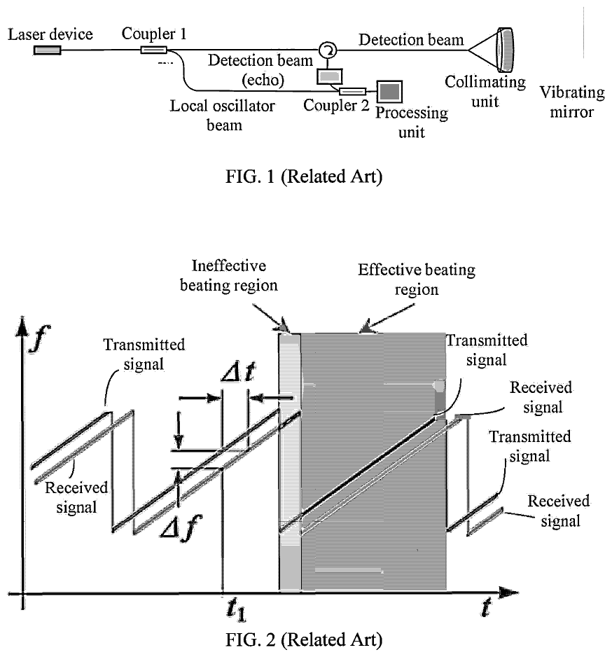

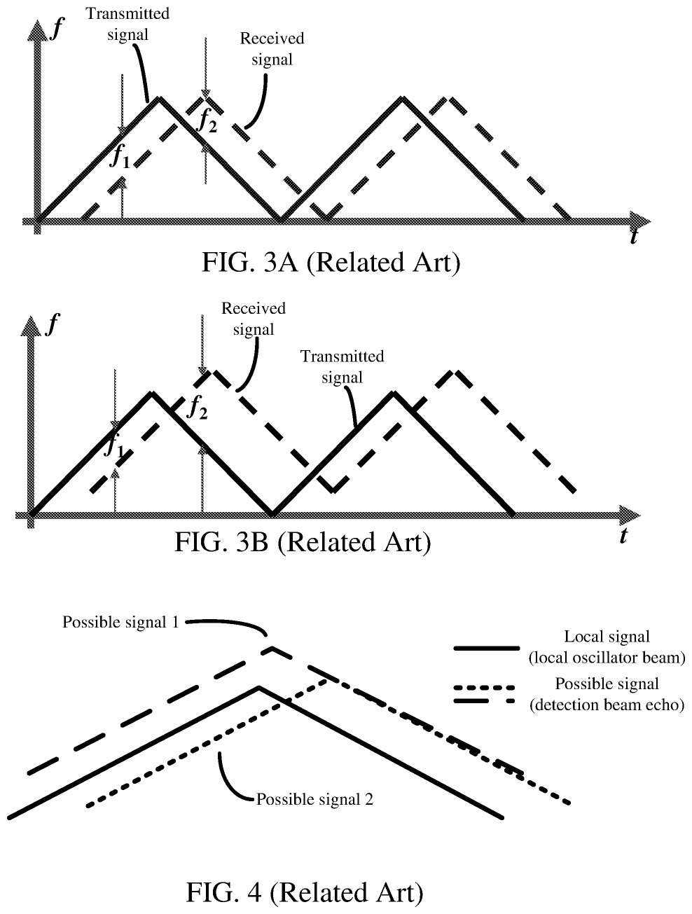

As shown in FIG. 12, the lidar 100 includes a light-emitter 101, a sensor unit 102, a mirror unit 103, and a processor unit 104. The light-emitter 101 may transmit a detection wave L1 based on a frequency sweep waveform, wherein a cycle of the frequency sweep waveform includes a rising edge, a horizontal region, and a falling edge, as shown in FIG. 6A, FIG. 6B, and FIG. 6C. The detection wave L1 is incident onto the mirror unit 103. The mirror unit 103 may include a vibrating mirror or a rotating mirror. The detection wave L1 is reflected in different directions through swinging or rotation and then transmitted into a surrounding space. The detection wave covers a field of view of the lidar, and is used for detecting a target object OB. The detection wave L1 is diffusely reflected from the target object, and an echo L1′ returns to the lidar 100, and may be received by the mirror unit 103 and reflected to the sensor unit 102. The sensor unit 102 includes a photoelectric detector which may receive the echo L1′ of the detection wave L1 reflected from the target object OB and convert the echo to an electrical signal. The light-emitter 101 and the sensor unit 102 further include, for example, a beam shaping unit, such as a collimating unit shown in FIG. 1, for collimating an emergent detection wave or an echo. The processor unit 104 is coupled to the light-emitter 101 and the sensor unit 102. The processor 104 may obtain a distance to and/or a speed of the target object based on the echo L1′ and the detection wave L1. A person skilled in the art may easily understand that FIG. 12 shows a functional block diagram rather than an actual structure diagram of the lidar 100. The lidar 100 may preferably adopt the FMCW lidar structure shown in FIG. 1, in which the light-emitter 101 may include a laser device and a signal generating unit, such as a DAC that generates a modulated waveform. The laser device may transmit a laser beam, and the signal generating unit may generate a frequency sweep waveform, and then modulate the laser beam by using the preset frequency sweep waveform to generate the detection wave L1. The sensor unit 102 may include a vibrating mirror and a collimating unit shown in FIG. 1. The vibrating mirror may receive the echo L1′ and reflect the echo onto the collimating unit, and the collimating unit may converge the echo L1′. The processor unit 104 may perform calculation and processing based on the detection wave L1 and the echo L1′.

According to an aspect of the present disclosure, the horizontal region is connected to the rising edge and the falling edge during a cycle of the frequency sweep waveform, as shown in the waveform in FIG. 6A. In some embodiments, the horizontal region is separated from the rising edge and the falling edge, as shown in the waveforms in FIG. 6B and FIG. 6C.

According to an aspect of the present disclosure, the processor unit may:
determine whether an amplitude corresponding to a frequency f_{d} of a beating signal between the detection wave and the echo in the horizontal region is greater than or equal to an amplitude threshold;
determine a distance frequency shift component f_{z} and a speed frequency shift component fᵥ depending on whether the amplitude corresponding to the frequency f_{d} of the beating signal between the detection wave and the echo in the horizontal region is greater than or equal to the amplitude threshold; and
determine the distance to and the speed of the target object based on the distance frequency shift component f_{z} and the speed frequency shift component fᵥ.

According to an aspect of the present disclosure, the processor unit may:
determine which of |f₂+f₁|/2 and |f₂+f₁|/2 is closer to f_{d} when the amplitude corresponding to the frequency f_{d} of the beating signal between the detection wave and the echo in the horizontal region is greater than or equal to the amplitude threshold, where f₁ is an absolute value of a frequency difference between the detection wave and the echo in the rising edge, and f₂ is an absolute value of a frequency difference between the detection wave and the echo in the falling edge;
in response to determining that |f₂−f₁|/2 is closer than |f₂+f₁|/2 to f_{d}, determine the distance frequency shift component f_{z} and the speed frequency shift component fᵥ according to:

$${f}_{z} = \frac{{f}_{2} + {f}_{1}}{2} , and {f}_{v} = \frac{{f}_{2} - {f}_{1}}{2} ;$$

and
in response to determining that |f₂+f₁|/2 is closer than |f₂−f₁|/2 to f_{d}, determine the distance frequency shift component f_{z} and the speed frequency shift component fᵥ according to: if

$${f}_{1} > {f}_{2} , {f}_{z} = \vert \frac{{f}_{2} - {f}_{1}}{2} \vert ,$$

$$then {f}_{v} = - \frac{{f}_{2} + {f}_{1}}{2} ;$$

$$and if {f}_{1} < {f}_{2} ,$$

$${f}_{z} = \vert \frac{{f}_{2} - {f}_{1}}{2} \vert ,$$

$$then {f}_{v} = \frac{{f}_{2} + {f}_{1}}{2} .$$

According to an aspect of the present disclosure, the processor unit may:
determine the presence of multiple echoes by determining that at least one of a number of absolute values f₁ of the frequency differences in the rising edge and/or a number of absolute values f₂ of the frequency differences in the falling edge is greater than 1; and
perform echo matching for the multiple echoes, and retain one of the absolute values f₁ in the rising edge and one of the absolute values f₂ in the falling edge.

According to an aspect of the present disclosure, the processor unit may perform the echo matching by: selecting a pair of f₁ and f₂ satisfying

$${f}_{d} = \vert \frac{{f}_{2} + {f}_{1}}{2} \vert or {f}_{d} = \vert \frac{{f}_{2} - {f}_{1}}{2} \vert ,$$

and discarding the remaining absolute values f₁ and f₂.

According to an aspect of the present disclosure, in response to that the amplitude corresponding to the frequency f_{d} of the beating signal between the detection wave and the echo in the horizontal region is less than the amplitude threshold, the processor unit may determine the distance frequency shift component f_{z} and the speed frequency shift component fᵥ according to:

$${f}_{z} = \frac{{f}_{2} + {f}_{1}}{2} , and {f}_{v} = \frac{{f}_{2} - {f}_{1}}{2} .$$

According to an aspect of the present disclosure, the processor unit may:
determine a presence of multiple echoes by determining that at least one of a number of absolute values f₁ of the frequency differences in the rising edge and/or a number of absolute values f₂ of the frequency differences in the falling edge is greater than 1; and
perform echo matching for the multiple echoes, and retain one of the absolute values f₁ in the rising edge and one of the absolute values f₂ in the falling edge.

According to an aspect of the present disclosure, the processor unit may perform the echo matching by:
determining a generated frequency shift F based on a moving speed of a device transmitting the detection wave; and
selecting a pair of the absolute values f₁ and f₂ such that

$$\frac{{f}_{2} - {f}_{1}}{2}$$

is closest to F, and discarding the remaining absolute values f₁ and f₂.

Finally, it should be noted that the above description is merely embodiments of the present disclosure, and is not intended to limit the present disclosure. Although the present disclosure has been described in detail with reference to the above embodiments, a person of ordinary skill in the art may make modifications to the technical solutions described in the above embodiments, or make equivalent replacements to some technical features in the technical solutions. Any modification, equivalent replacement, improvement, and the like made within the spirit and principle of the present disclosure shall fall within the protection scope of the present disclosure.

What is claimed is:

1. A method for detection using a frequency modulated continuous wave (FMCW), comprising:
transmitting a detection wave consistent with a frequency sweep waveform to detect a target object;
receiving an echo of the detection wave reflected from the target object; and
obtaining at least one of a distance to the target object or a speed of the target object based on the echo and the detection wave, wherein
a cycle of the frequency sweep waveform comprises a rising edge, a horizontal region, and a falling edge.

2. The method of claim 1, wherein the horizontal region is connected to the rising edge and the falling edge during the cycle of the frequency sweep waveform.

3. The method of claim 1, wherein the horizontal region is separated from the rising edge and the falling edge during the cycle of the frequency sweep waveform.

4. The method of claim 1, wherein obtaining at least one of the distance to the target object or the speed of the target object based on the echo and the detection wave comprises:
determining whether an amplitude corresponding to a frequency f_{d} of a beating signal is greater than or equal to an amplitude threshold, wherein the beating signal is between the detection wave and the echo in the horizontal region;
determining a distance frequency shift component f_{z} and a speed frequency shift component fᵥ depending on whether the amplitude corresponding to the frequency f_{d} of the beating signal is greater than or equal to the amplitude threshold; and
determining at least one of the distance to the target object or the speed of the target object based on the distance frequency shift component f_{z} and the speed frequency shift component fᵥ.

5. The method of claim 4, wherein determining the distance frequency shift component f_{z} and the speed frequency shift component fᵥ comprises:
determining which of |f₂+f₁|/2 and |f₂−f₁|/2 is closer to f_{d} when the amplitude corresponding to the frequency f_{d} of the beating signal is greater than or equal to the amplitude threshold, wherein f₁ is an absolute value of a frequency difference between the detection wave and the echo in the rising edge, and f₂ is an absolute value of a frequency difference between the detection wave and the echo in the falling edge;
in response to determining that |f₂−f₁|/2 is closer than |f₂+f₁|/2 to f_{d}, determining the distance frequency shift component f_{z} and the speed frequency shift component fᵥ:
$${f}_{z} = \frac{{f}_{2} + {f}_{1}}{2} , and {f}_{v} = \frac{{f}_{2} - {f}_{1}}{2} ;$$
and
in response to determining that |f₂−f₁|/2 is closer than |f₂+f₁|/2 to f_{d}, determining the distance frequency shift component f_{z} and the speed frequency shift component fᵥ according to: if
$${f}_{1} > {f}_{2} , {f}_{z} = \vert \frac{{f}_{2} - {f}_{1}}{2} \vert ,$$
$$and {f}_{v} = - \frac{{f}_{2} + {f}_{1}}{2} ;$$
$$and if {f}_{1} < {f}_{2} ,$$
$${f}_{z} = \vert \frac{{f}_{2} - {f}_{1}}{2} \vert ,$$
$$and {f}_{v} = \frac{{f}_{2} + {f}_{1}}{2} .$$

6. The method of claim 4, further comprising:
determining a presence of multiple echoes based on a determination that at least one of a number of absolute values f₁ of frequency differences in the rising edge or a number of absolute values f₂ of frequency differences in the falling edge is greater than 1; and
performing echo matching for the multiple echoes, and retaining one of the absolute values f₁ in the rising edge and one of the absolute values f₂ in the falling edge.

7. The method of claim 6, wherein performing echo matching for the multiple echoes comprises: selecting a pair of the absolute values f₁ and f₂ consistent with
$${f}_{d} = \vert \frac{{f}_{2} + {f}_{1}}{2} \vert or {f}_{d} = \vert \frac{{f}_{2} - {f}_{1}}{2} \vert ,$$
and discarding remaining absolute values f₁ and f₂.

8. The method of claim 4, wherein determining the distance frequency shift component f_{z} and the speed frequency shift component fᵥ comprises:
in response to the amplitude corresponding to the frequency f_{d} of the beating signal being less than the amplitude threshold, determining the distance frequency shift component f_{z} and the speed frequency shift component fᵥ according to:
$${f}_{z} = \frac{{f}_{2} + {f}_{1}}{2} , and {f}_{v} = \frac{{f}_{2} - {f}_{1}}{2} .$$

9. The method of claim 8, further comprising:
determining a presence of multiple echoes based on a determination that at least one of a number of absolute values f₁ of frequency differences in the rising edge or a number of absolute values f₂ of frequency differences in the falling edge is greater than 1; and
performing echo matching for the multiple echoes, and retaining one of the absolute values f₁ in the rising edge and one of the absolute values f₂ in the falling edge.

10. The method of claim 9, wherein performing echo matching for the multiple echoes comprises:
determining a generated frequency shift F based on a moving speed of a device transmitting the detection wave; and
selecting a pair of the absolute values f₁ and f₂ such that
$$\frac{{f}_{2} - {f}_{1}}{2}$$
is closest to F, and discarding remaining absolute values f₁ and f₂.

11. A lidar, comprising:
a light-emitter, configured to transmit a detection wave consistent with a frequency sweep waveform, wherein a cycle of the frequency sweep waveform comprises a rising edge, a horizontal region, and a falling edge;
a mirror unit, configured to receive and reflect and transmit the detection wave to detect a target object;
a sensor unit, wherein an echo of the detection wave reflected from the target object is reflected by the mirror unit and then incident onto the sensor unit; and
a processor unit, coupled to the light-emitter and the sensor unit and configured to obtain at least one of a distance to the target object or a speed of the target object based on the echo and the detection wave.

12. The lidar of claim 11, wherein the horizontal region is connected to the rising edge and the falling edge during the cycle of the frequency sweep waveform.

13. The lidar of claim 11, wherein the horizontal region is separated from the rising edge and the falling edge during the cycle of the frequency sweep waveform.

14. The lidar of claim 11, wherein the processor unit is configured to:
determine whether an amplitude corresponding to a frequency f_{d} of a beating signal is greater than or equal to an amplitude threshold, wherein the beating signal is between the detection wave and the echo in the horizontal region;
determine a distance frequency shift component f_{z} and a speed frequency shift component fᵥ depending on whether the amplitude corresponding to the frequency f_{d} of the beating signal is greater than or equal to the amplitude threshold; and
determine at least one of the distance to the target object or the speed of the target object based on the distance frequency shift component f_{z} and the speed frequency shift component fᵥ.

15. The lidar of claim 14, wherein the processor unit is configured to:
determine which of |f₂+f₁|/2 and |f₂−f₁|/2 is closer to f_{d} when the amplitude corresponding to the frequency f_{d} of the beating signal is greater than or equal to the amplitude threshold, wherein f₁ is an absolute value of a frequency difference between the detection wave and the echo in the rising edge, and f₂ is an absolute value of a frequency difference between the detection wave and the echo in the falling edge;
in response to determining that |f₂−f₁|/2 is closer than |f₂+f₁|/2 to f_{d}, determine the distance frequency shift component f_{z} and the speed frequency shift component fᵥ according to:
$${f}_{z} = \frac{{f}_{2} + {f}_{1}}{2} , and {f}_{v} = \frac{{f}_{2} - {f}_{1}}{2} ;$$
and
in response to determining that |f₂+f₁|/2 is closer than |f₂−f₁|/2 to f_{d}, determine the distance frequency shift component f_{z} and the speed frequency shift component fᵥ according to: if
$${f}_{1} > {f}_{2} , {f}_{z} = \vert \frac{{f}_{2} - {f}_{1}}{2} \vert ,$$
$$and {f}_{v} = - \frac{{f}_{2} + {f}_{1}}{2} ;$$
$$and if {f}_{1} < {f}_{2} ,$$
$${f}_{z} = \vert \frac{{f}_{2} - {f}_{1}}{2} \vert ,$$
$$and {f}_{v} = \frac{{f}_{2} + {f}_{1}}{2} .$$

16. The lidar of claim 14, wherein the processor unit is configured to:
determine a presence of multiple echoes based on a determination that at least one of a number of absolute values f₁ of frequency differences in the rising edge or a number of absolute values f₂ of frequency differences in the falling edge is greater than 1; and
perform echo matching for the multiple echoes, and retain one of the absolute values f₁ in the rising edge and one of the absolute values f₂ in the falling edge.

17. The lidar of claim 16, wherein the processor unit configured to perform the echo matching for the multiple echoes is further configured to selecting a pair of the absolute values f₁ and f₂ consistent with
$${f}_{d} = \vert \frac{{f}_{2} + {f}_{1}}{2} \vert or {f}_{d} = \vert \frac{{f}_{2} - {f}_{1}}{2} \vert ,$$
and discarding remaining absolute values f₁ and f₂.

18. The lidar of claim 14, wherein in response to that the amplitude corresponding to the frequency f_{d} of the beating signal is less than the amplitude threshold, the processor unit is configured to determine the distance frequency shift component f_{z} and the speed frequency shift component fᵥ according to:
$${f}_{z} = \frac{{f}_{2} + {f}_{1}}{2} , and {f}_{v} = \frac{{f}_{2} - {f}_{1}}{2} .$$

19. The lidar of claim 18, wherein the processor unit is configured to:
determine a presence of multiple echoes based on a determination that at least one of a number of absolute values f₁ of frequency differences in the rising edge or a number of absolute values f₂ of frequency differences in the falling edge is greater than 1; and
perform echo matching for the multiple echoes, and retain one of the absolute values f₁ in the rising edge and one of the absolute values f₂ in the falling edge.

20. The lidar of claim 19, wherein the processor unit configured to perform the echo matching for the multiple echoes is further configured to
determining a generated frequency shift F based on a moving speed of a device transmitting the detection wave; and
selecting a pair of the absolute values f₁ and f₂ such that
$$\frac{{f}_{2} - {f}_{1}}{2}$$
is closest to F, and discarding remaining absolute values f₁ and f₂.
